(19) United States
(12) Patent Application Publication
(10) Pub. No.: US 2023/0085234 A1
(43) Pub. Date: Mar. 16, 2023

(54) LITHIUM COBALT-BASED OXIDE FOR LITHIUM SECONDARY BATTERY, METHOD OF PREPARING THE SAME, AND LITHIUM SECONDARY BATTERY INCLUDING CATHODE INCLUDING THE SAME

(71) Applicant: Samsung SDI Co., Ltd., Yongin-si (KR)

(72) Inventors: Sangmi Kim, Yongin-si (KR); Youngki Kim, Yongin-si (KR); Hyunjei Chung, Yongin-si (KR); Jaeyoung Jeong, Yongin-si (KR); Yongmok Cho, Yongin-si (KR); Minjae Choi, Yongin-si (KR); Sungho Choo, Yongin-si (KR)

(21) Appl. No.: 17/806,833

(22) Filed: Jun. 14, 2022

(30) Foreign Application Priority Data
Sep. 3, 2021 (KR) 10-2021-0117739

(51) Int. Cl. H01M 4/525; H01M 4/505; H01M 10/0525

(52) U.S. Cl. CPC H01M 4/525; H01M 4/505; H01M 10/0525; H01M 2004/021

(57) ABSTRACT

Disclosed are a lithium cobalt-based oxide for a lithium secondary battery, a method of preparing the lithium cobalt-based oxide, and a lithium secondary battery including a cathode including the lithium cobalt-based oxide, wherein the lithium cobalt-based oxide includes aluminum in an amount of 4,000 ppm to 6,500 ppm based on the total weight of lithium cobalt-based oxide and includes large particles and small particles, and in a differential capacity (dQ/dV)-voltage charge-discharge graph of the lithium secondary battery, discharge peaks appearing at a voltage in a range of 4.7 V to 3 V include Peak 1 appearing at a discharge voltage of 4.6 V or more, and Peak 2 appearing at a discharge voltage of 4.55 V or less, in which Peak 2 has a greater intensity than that of Peak 1.

### CROSS-REFERENCE TO RELATED APPLICATION

This application claims priority to and the benefit of Korean Patent Application No. 10-2021-0117739, filed on Sep. 3, 2021, in the Korean Intellectual Property Office, the entire content of which is hereby incorporated by reference.

### BACKGROUND

### 1. Field

Provided are a lithium cobalt-based oxide for a lithium secondary battery, a method of preparing the lithium cobalt-based oxide, and a lithium secondary battery including a cathode including the lithium cobalt-based oxide.

### 2. Description of the Related Art

Lithium cobalt oxide (LiCoO₂) is widely used as a cathode active material of lithium secondary batteries. In order to manufacture lithium secondary batteries having high energy density, lithium cobalt oxide, which can be used at high voltages, may be used.

However, lithium cobalt oxide undergoes a phase transition to an irreversible structure at high voltages, causing the dissolution of cobalt or formation of oxygen, and as surface electrolytes disintegrate, gas is generated, which causes swelling of pouch-type cells, and consequently, high-temperature lifespan and high-temperature storage characteristics of the battery are deteriorated (e.g., reduced).

### SUMMARY

One aspect of embodiments of the present disclosure provides a lithium cobalt-based oxide for a lithium secondary battery, having improved stability at high voltages, and a method of preparing the lithium cobalt-based oxide.

Another aspect of embodiments of the present disclosure provides a lithium secondary battery including a cathode that includes the aforementioned lithium cobalt-based oxide for a lithium secondary battery, and thus has improved stability at high voltages and improved cell performance.

Additional aspects of embodiments of the present disclosure will be set forth in part in the description which follows and, in part, will be apparent from the description, or may be learned by practice of the presented embodiments of the disclosure.

According to one aspect of embodiments of the present disclosure, there is provided a lithium cobalt-based oxide for a lithium secondary battery, the lithium cobalt-based oxide including aluminum in an amount of 4,000 ppm to 6,500 ppm based on the total weight of lithium cobalt-based oxide, wherein the lithium cobalt-based oxide includes large particles and small particles, and on a differential capacity (dQ/dV)-voltage charge-discharge graph of the lithium secondary battery, a discharge peak that appears at a voltage of 4.7 V to 3 V includes Peak 1 appearing at a discharge voltage of 4.6 V or more, and Peak 2 appearing at a discharge voltage of 4.55 V or less, and wherein Peak 2 has a greater intensity than that of Peak 1. According to another aspect of embodiments of the present disclosure, a lithium secondary battery including a cathode containing the aforementioned lithium cobalt-based oxide is provided.

According to another aspect of embodiments of the present disclosure, there is provided a method of preparing a lithium-cobalt composite oxide for a lithium secondary battery, the method including: obtaining a first mixture by mixing together a lithium precursor, an aluminum precursor, and a cobalt precursor having a particle size of 4 μm to 7 μm, and forming a lithium cobalt-based oxide having a large particle size by performing a first heat treatment on the first mixture; obtaining a second mixture by mixing together a lithium precursor, an aluminum precursor, and a cobalt precursor having a size of 2 μm to 3 μm, and forming a lithium cobalt-based oxide having a small particle size by performing a second heat treatment on the second mixture; and obtaining a third mixture by mixing together the lithium cobalt-based oxide having the large particle size and the lithium cobalt-based oxide having the small particle size, and preparing a lithium cobalt-based oxide by performing a third heat treatment on the third mixture, wherein in the preparation of the lithium cobalt-based oxide having the large particle size or the lithium cobalt-based oxide having the small particle size, a mixing molar ratio of lithium with respect to metal (Li/Me) is in a range of 1.03 to 1.05, and wherein in the preparation of the lithium cobalt-based oxide the large particle size or the lithium cobalt-based oxide having the small particle size, a temperature elevation rate is 3° C./min or more.

### BRIEF DESCRIPTION OF THE DRAWINGS

The above and other aspects and features of certain embodiments of the disclosure will be more apparent from the following description taken in conjunction with the accompanying drawings, in which:

FIG. 1 shows charge-discharge differential curves, obtained by taking the derivative of charge-discharge capacity over voltage (dQ/dV) in lithium secondary batteries manufactured according to Manufacturing Examples 1 to 4 and a lithium secondary battery manufactured according to Comparative Manufacturing Example 1;

FIG. 2A shows lifespan characteristics at a high temperature (45° C.) and a high voltage (4.7 V) of lithium secondary batteries manufactured according to Manufacturing Examples 1 to 4, and a lithium secondary battery manufactured according to Comparative Manufacturing Example 1;

FIG. 2B shows lifespan characteristics at a high temperature (45° C.) and a high voltage (4.58 V) of lithium secondary batteries manufactured according to Manufacturing Examples 1 to 4, and a lithium secondary battery manufactured according to Comparative Manufacturing Example 1;

FIG. 3 is a perspective schematic view of a representative structure of a lithium secondary battery according to one example; and

FIG. 4 shows high-temperature continuous charging characteristics of lithium secondary batteries manufactured according to Manufacturing Example 1, Manufacturing Example 4, and Comparative Manufacturing Example 1.

### DETAILED DESCRIPTION

Reference will now be made in more detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of embodiments of the present description. As used herein, the term “and/or” includes any and all combinations of one or more of the associated listed items. Expressions such as “at least one of,” when preceding a list of elements, modify the entire list of elements and do not modify the individual elements of the list.

Hereinbelow, a lithium cobalt-based oxide for a lithium secondary battery, a method of preparing the lithium cobalt-based oxide, and a lithium secondary battery including a cathode including the lithium cobalt-based oxide according to examples are described in greater detail herein below.

Lithium cobalt-based compounds (LiCoO₂) have a structure in which lithium, cobalt, and oxygen are alternatingly positioned on lattice [111] planes in a crystal having a rock-salt structure (an O3-type layered structure). In lithium secondary batteries using such a lithium cobalt-based oxide, upon charging, lithium ions in the crystal lattice of the lithium cobalt-based oxide undergo deintercalation out of the lattice. However, as the charging voltage increases, the amount of lithium ions being deintercalated from the crystal lattice of the lithium cobalt-based oxide also increases, thus causing at least a portion of the O3-type layered structure to undergo a phase transition to an O1-type layered structure, which does not have Li in its crystal lattice. Accordingly, a charging voltage in a high voltage range of 4.52 V or higher (full cell) may cause phase transitions to an H1-3 type layered structure, in which the O3-type layered structure and the O1-type layered structure coexist together in the crystal lattice of the lithium cobalt-based oxide. Such phase transitions from the O3-type layered structure to the H1-3 type layered structure or to the O1-type layered structure are, at least in part, irreversible, and in the H1-3 type layered structure and the O1-type layered structure, the amount of lithium ions available for intercalation/deintercalation is reduced, thereby reducing the capacity of the lithium secondary battery. Such phase transitions may be accompanied by dissolution of cobalt in the lithium cobalt-based oxide, oxygen formation, and gas formation due to surface electrolyte decomposition, which causes swelling of pouch-type cells, and, consequently, storage and lifetime characteristics of the lithium secondary battery are inevitably decreased.

To address the above-described problems, by doping a lithium cobalt oxide with aluminum (Al) at 4,000 ppm to 6,500 ppm based on the total weight of the lithium cobalt-based oxide, the present inventors provide a lithium cobalt-based oxide in which such phase transitions are controlled or reduced, even under high voltage conditions.

Here, aluminum (Al) content ppm refers to the mass of Al with respect to one million of the total mass of the lithium cobalt oxide.

According to one example, the lithium cobalt-based oxide for a lithium secondary battery has an aluminum content of about 4,000 ppm to about 6,500 ppm based on the total weight of lithium cobalt-based oxide, wherein the lithium cobalt-based oxide contains a large particle and a small particle. In addition, on a differential capacity (dQ/dV)-voltage charge-discharge graph of a lithium secondary battery including the lithium cobalt-based oxide, discharge peaks that appear at a discharge voltage of 4.7 V to 3 V include Peak 1 that appears at a voltage of 4.6 V or more, and Peak 2 that appears at a voltage of 4.55 V or less, wherein Peak 2 has a greater intensity than that of Peak 1.

The differential capacity-voltage charge-discharge graph is obtained at a voltage of 4.7 V to 3 V.

In the differential capacity (dQ/dV)-voltage charge-discharge graph, V represents a voltage with respect to lithium metal at the cathode, and Q represents a charge capacity of the lithium secondary battery. In addition, on the charge-discharge graph, the X axis represents voltage V, and the Y axis represents a value (dQ/dv) obtained by taking the derivative of the charge-discharge capacity (C) with respect to the voltage (V).

Charge-discharge conditions for the lithium secondary battery are as follows.

The lithium secondary battery undergoes constant-current charging at a current level of 0.01 C to 0.1 C, for example, 0.05 C, until a voltage level of 4.65 V to 4.75 V, for example, 4.7 V, is reached, and then undergoes constant-voltage charging until a current level of 0.005 C to 0.02 C, for example, 0.01 C, is reached. The fully charged lithium secondary battery undergoes a resting period of about 5 minutes to about 20 minutes, for example, 10 minutes, and then is subjected to constant-current discharging at a current level of about 0.01 C to about 0.1 C, for example, 0.05 C, until a voltage level of 3 V is reached. The lithium secondary battery is evaluated by repeating this cycle a plurality of times.

In the present application, the “dQ/dV charge-discharge graph” relates to the first cycle, wherein charging peaks appear at, for example, in a range of about 4.55 V to about 4.65 V, and discharge peaks appear at, for example, in a range of about 4.49 V to about 4.65 V, or of about 4.54 V to about 4.63 V.

The dQ/dV charge-discharge graph shows capacity characteristics of operating ions in lithium cobalt-based oxides, which are cathode active materials, at different voltages. In the dQ/dV charge-discharge graph, positions of other peaks relative to the main peak, a difference in intensity between the main peak and other peaks, and an area difference between the main peak and other peaks may vary depending on the type or kind of cathode active material and physical properties of cathode active material. Here, the main peak refers to a peak with the highest intensity.

In the absence of Peak 1, at high voltages of 4.5 V or higher, LCO undergoes the phase transition to an irreversible structure (from the O3-type layered structure to the H1-3 type layered structure to the O1-type layered structure), causing Co dissolution and generating oxygen. Further, gas is generated as electrolytes decompose at surfaces of the lithium cobalt-based oxide, causing expansion of the pouch cell, which may lead to degradation in high-temperature lifetime and high-temperature storage characteristics of the battery. However, in the presence of Peak 1, the above-described phase transition of the lithium cobalt-based oxide to the irreversible structure is prevented or reduced, and thus, can have improved phase stability at high voltages and consequently improved high-temperature lifespan at high voltages.

Peak 1 appears at, for example, a discharge voltage of 4.6 V to 4.65 V. The presence of Peak 1 indicates that the phase transition to the O1-type layered structure, which is an irreversible phase change, occurs to a lesser degree at higher voltages, and because there is less of the irreversible phase change, when charging and discharging are repeated, high-temperature lifespan and high-temperature continuous charging characteristics are improved.

The ratio (I_{B}/I_{A}) of intensity (I_{B}) of Peak 2 to intensity (I_{A}) of Peak 1 is in the range of about 1.1 to about 1.7, or in the range of about 1.2 to about 1.6. When the intensity ratio (I_{B}/I_{A}) is within the above ranges, it is possible to effectively prevent or reduce a phase transition of the lithium cobalt oxide to an irreversible structure at high voltages, and thus, high-voltage stability is improved.

Other than Peak 1 and Peak 2, additional peaks may appear in the range of about 3.9 V to about 4.5 V.

For a lithium secondary battery including a lithium cobalt-based oxide according to one example, the second cycle (two cycles) differential capacity (dQ/dV)-voltage charge-discharge graph is almost identical to the shape of the first cycle (one cycle) differential capacity(dQ/dV)-voltage charge-discharge graph. From this result, it can be confirmed that the phase structure of the cathode active material remains uniform (e.g., substantially uniform) even after the first charge-discharge cycle. For example, the phase stability of the lithium cobalt-based oxide can be improved, and the charge-discharge capacity, charge-discharge efficiency, and lifespan characteristics of the lithium secondary battery can be improved by reducing the irreversible phase transition of the lithium cobalt-based oxide.

The mixing weight ratio of the large particle to the small particle is in the range of about 8:2 to about 9:1, and for example, in the range of about 5:1 to about 7:1. When the mixing weight ratio of the large particle to the small particle is within the above ranges, the high-temperature lifespan and high-temperature continuous charging characteristics of the lithium secondary battery can be improved.

The large particle has a size of about 17 μm to about 21 μm, and for example, a size of about 18 μm to about 20 μm. In addition, the small particle has a size of about 2 μm to about 8 μm, and for example, about 2 μm to about 5 μm, or about 3 μm to about 4 μm.

The lithium cobalt-based oxide according to one example may be, for example, a compound represented by Formula 1 below.

LiₐMg_{b}CO_{1-x-y-b}AlₓM_{y}O₂ Formula 1

In Formula 1, 0.9≤a≤1.05, 0.001≤b≤0.01, 0.01<x≤0.03, and 0≤y<0.01, and M is Ti, Mn, Ni, Mo, Zr, Y, W, Sr, Zn, or a combination thereof.

In some embodiments, in Formula 1, 0.017<x≤0.03.

In the compound of Formula 1, the aluminum content is in the range of about 4,000 ppm (about 1.61 mol %) to about 6,500 ppm (about 2.62 mol %) based on the total weight of lithium cobalt-based oxide, and if the aluminum content is less than 4,000 ppm based on the total weight of lithium cobalt-based oxide, irreversible phase-transitions occur at low voltages, and thus, Peak 1 does not exist (e.g., is not observable in the dQ/dV charge-discharge graph after the first cycle) and high-temperature lifespan and high-temperature continuous charging characteristics of the lithium secondary battery may be deteriorated (e.g., reduced). If the aluminum content in the compound of Formula 1 exceeds 6,500 ppm based on the total weight of lithium cobalt-based oxide, it is difficult to realize the capacity of 0.2 C.

The lithium cobalt-based oxide according to one example may further include a lithium titanium-based compound on its surface.

Such a lithium titanium-based compound may be positioned in the form of an island. For example, the lithium titanium-based compound may be present on the surface of the lithium cobalt-based oxide as a plurality of discrete islands of the lithium titanium-based compound that do not physically contact one another on the same particle of the lithium cobalt-based oxide. As such, when the lithium titanium-based compound exists, it is possible to prepare lithium secondary batteries having improved resistance, capacity, and high-temperature lifespan.

A lithium cobalt-based oxide according to one example has a layered crystal structure and has a specific surface area of about 0.1 m²/g to about 3 m²/g.

Hereinafter, a preparation method of a lithium cobalt-based compound according to one example will be described.

First, a lithium precursor, an aluminum precursor, and a cobalt precursor having a particle size of about 4 μm to about 7 μm are mixed together to prepare a first mixture.

In some embodiments, when mixing these precursors together, by stoichiometrically controlling the mixing ratio of the lithium precursor, the cobalt precursor, and the aluminum precursor so as to produce a target lithium cobalt-based oxide, a first mixture can be obtained.

In the preparation of the first mixture and the second mixture, a magnesium precursor may be further added.

One or more precursors selected from among a titanium precursor, a manganese precursor, a nickel precursor, a molybdenum precursor, a zirconium precursor, an yttrium precursor, a tungsten precursor, a strontium precursor, and a zinc precursor, may be further added to the first mixture.

For the lithium precursor, one or more selected from among lithium hydroxide (LiOH), lithium carbonate (Li₂CO₃), lithium chloride, lithium sulfate (Li₂SO₄), and lithium nitrate (LiNO₃) may be used. For the cobalt precursor, one or more selected from among cobalt carbonate, cobalt hydroxide, cobalt chloride, cobalt sulfate, and cobalt nitrate may be used. For the aluminum precursor, one or more selected from among aluminum sulfate, aluminum chloride, aluminum hydroxide may be used. For the magnesium precursor, one or more selected from among magnesium sulfate, magnesium chloride, and magnesium hydroxide may be used. In addition, for the manganese precursor, the nickel precursor, the molybdenum precursor, the zirconium precursor, the yttrium precursor, the tungsten precursor, the strontium precursor, and the zinc precursor, hydroxides, chlorides, sulphates, and oxides, containing manganese, nickel, molybdenum, zirconium, yttrium, tungsten, strontium, and zinc, may be used, respectively.

The mixing may be carried out by means of dry mixing such as mechanical mixing, by using, for example, a ball mill, a Banbury mixer, a homogenizer, a Henschel mixer, and/or the like. The dry mixing may reduce the production cost in comparison to wet mixing.

When the cobalt precursor has a particle size of less than 4 μm, it is difficult to obtain a large lithium cobalt-based oxide having a target size. Further, when a particle size of the cobalt precursor exceeds 7 μm, the capacity of the lithium secondary battery is low.

Thereafter, the large lithium cobalt-based oxide may be obtained by performing a first heat-treatment on the first mixture in ambient atmosphere or an oxygen atmosphere. The large lithium cobalt-based oxide has a particle size in the range of about 17 μm to about 21 μm, for example, about 18 μm to about 20 μm, and for example, a size of 19 μm.

Apart from the above, a second mixture is obtained by mixing a lithium precursor, an aluminum precursor, and a cobalt precursor having a particle size of 2 μm to 3 μm, and a small lithium cobalt-based oxide is prepared by performing a second heat-treatment on the second mixture.

In the preparation of the large lithium cobalt-based oxide and the small lithium cobalt-based oxide, the first heat-treatment and the second heat-treatment are carried out at a temperature in the range of about 800° C. to about 1,000° C., or in the range of about 850° C. to about 980° C.

The small lithium cobalt-based oxide has a particle size of about 2 μm to about 8 μm, for example, of about 3 μm to about 4 μm.

When the cobalt precursor used for the preparation of the small lithium cobalt-based oxide has a particle size of less than 2 μm, it is difficult to obtain the small lithium cobalt-based oxide having a target size. In addition, when a size of the cobalt precursor exceeds 3 μm, the particle size is too big to obtain small particles.

In the present application, the term “particle size” “size” refers to an average particle diameter if the particle sought to be measured is spherical, and for a particle that is non-spherical, said term refers to a major axis length of the particle. The particle size may be evaluated using a particle size analyzer, a scanning electron microscope, or a transmission electron microscope. For the particle size analyzer, a LA-950 laser particle size analyzer by HORIBA may be used.

When measuring a particle size by using the particle size analyzer, an average particle size is represented by D50. D50 refers to an average particle diameter of particles having a cumulative volume of 50 vol % in a particle distribution, and on a distribution curve obtained by accumulating particles from the smallest particle size to the largest particle size where the total number of the particles is assumed to be 100%, D50 refers to a value of a particle diameter at 50% counted from the smallest particle. D50 can be measured by using a particle size analyzer. In some embodiments, D50 can be measured using a measurement device using dynamic light-scattering, and by performing data analysis and counting the number of particles in each particle size range, D50 can be easily obtained through calculation therefrom.

In the above-described preparations of the large lithium cobalt-based oxide and the small lithium cobalt-based oxide, the mixing molar ratio (Li/Me) of lithium with respect to metal is in a range of about 1.03 to about 1.05, or of about 1.04 to about 1.05. In the present application, the metal in the mixing molar ratio of lithium with respect to metal refers to a metal other than lithium.

In the preparations of the large lithium cobalt-based oxide and the small lithium cobalt-based oxide, the temperature elevation rate is in a range of about 4° C./min to about 6° C./min. When the temperature elevation rate is carried out within the above range, particles are grown to a size of 19 μm, and the lithium secondary battery shows desirable capacity characteristics.

A third mixture is obtained by mixing the large lithium cobalt-based oxide and the small lithium cobalt-based oxide in a weight ratio of about 8:2 to about 1:9, and is subjected to a third heat-treatment. The third heat-treatment has a temperature elevation rate of about 4° C./min to about 6° C./min, and may be conducted in a range of about 800° C. to about 1,000° C., and for example, at 900° C.

Prior to conducting the second heat-treatment described above, a cobalt precursor and a titanium precursor may be further added.

The content of the titanium precursor may be in a range of about 500 ppm to about 700 ppm based on the total weight of lithium cobalt-based oxide. In addition, the content of the cobalt precursor is stoichiometrically controlled such that the mixing molar ratio (Li/Me) of lithium with respect to metal in the third mixture is controlled so as to be within a range of about 0.99 to about 1.

The cobalt precursor includes, for example, cobalt hydroxides, cobalt oxides, and/or the like, and the titanium precursor includes, for example, one or more selected from among titanium hydroxides, titanium chlorides, titanium sulfates, and titanium oxides.

Prior to performing the second heat-treatment, the mixing molar ratio (Li/Me) of lithium with respect to metal in the third mixture is controlled so as to be within a range of about 0.99 to about 1. When the mixing molar ratio (Li/Me) of lithium with respect to metal is within the above range, it is possible to prepare a lithium cobalt-based oxide having improved high-voltage phase stability.

The above-described third heat-treatment may be conducted under an air or an oxygen atmosphere at a temperature of about 400° C. to about 1,200° C., and for example, about 900° C. to about 1,100° C. Here, the oxygen atmosphere may be formed using oxygen alone, or may be formed using a mixture gas of oxygen, nitrogen and an inert gas. The duration of a heat treatment varies depending on the temperature of the heat-treatment. For example, the heat treatment may be conducted for about 5 hours to about 20 hours.

The lithium cobalt-based oxide may be prepared by any suitable preparation methods used in the art. In some embodiments, the lithium cobalt-based oxide may be prepared by methods such as, for example, spray pyrolysis, other than the above-described solid-state reaction.

According to another aspect of embodiments of the present disclosure, provided is a lithium secondary battery including a cathode including the above-described lithium cobalt-based oxide. Embodiments of the preparation method of the lithium secondary battery will be further described below.

Hereinbelow embodiments of the present disclosure will be described in more detail with respect to a preparation method of a lithium secondary battery including a cathode that includes a lithium cobalt-based oxide, which is a cathode active material according to one example, and an anode, a lithium salt-containing nonaqueous electrolyte, and a separator.

The cathode and the anode may be prepared by applying onto current collectors, a cathode active material layer-forming composition and an anode active material layer-forming composition, respectively, and drying the same, thereby forming a cathode active material layer and an anode active material layer, respectively.

The cathode active material layer-forming composition may be prepared by mixing together a cathode active material, a conductor, a binder, and a solvent. Here, the lithium cobalt-based oxide according to one example may be used as the cathode active material.

In the preparation of the cathode above, a first cathode active material, which is a cathode active material used for lithium secondary batteries, may be further included. The first cathode active material may further include one or more selected from the group consisting of lithium cobalt oxide, lithium nickel cobalt manganese oxide, lithium nickel cobalt aluminum oxide, lithium iron phosphate, and lithium manganese oxide, but is not limited thereto, and any suitable cathode active material available in the relevant technical field may be used. For example, the first cathode active material may utilize a compound represented by any one of the following formulas: LiₐA_{1-b}B_{b}D₂ (in this formula, 0.9≤a≤1.8 and 0≤b≤0.5); LiₐE_{1-b}B_{b}O_{2-c}D_{c} (in this formula, 0.90≤a≤1.8, 0≤b≤0.5, and 0≤c≤0.05); LiE_{2-b}B_{b}O_{4-c}D_{c} (in this formula, 0≤b≤0.5, and 0≤c≤0.05); LiₐNi_{1-b-c}Co_{b}B_{c}D_{α}(in this formula, 0.90≤a≤1.8, 0≤b≤0.5, 0≤c≤0.05, and 0<a≤2); LiₐNi_{1-b-c}Co_{b}B_{c}O_{2-α}F_{α}(in this formula, 0.90≤a≤1.8, 0≤b≤0.5, 0≤c≤0.05, and 0<α<2); LiₐNi_{1-b-c}Mn_{b}B_{c}D_{α}(in this formula, 0.90≤a≤1.8, 0≤b≤0.5, 0≤c≤0.05, and 0<α≤2); LiₐNi_{1-b-c}Mn_{b}B_{c}O_{2-α}F_{α}(in this formula, 0.90≤a≤1.8, 0≤b≤0.5, 0≤c≤0.05, and 0<α<2); LiₐNi_{b}E_{c}G_{d}O₂ (in this formula, 0.90≤a≤1.8, 0≤b≤0.9, 0≤c≤0.5, and 0.001≤d≤0.1); LiₐNi_{b}Co_{c}Mn_{d}GₑO₂ (in this formula, 0.90≤a≤1.8, 0≤b≤0.9, 0≤c≤0.5, 0≤d≤0.5, and 0.001≤e≤0.1); LiₐNiG_{b}O₂ (in this formula, 0.90≤a≤1.8 and 0.001≤b≤0.1); LiₐCoG_{b}O₂ (in this formula, 0.90≤a≤1.8 and 0.001≤b≤0.1); LiₐMnG_{b}O₂ (in this formula, 0.90≤a≤1.8 and 0.001≤b≤0.1); LiₐMn₂G_{b}O₄ (in this formula, 0.90≤a≤1.8 and 0.001≤b≤0.1); QO₂; QS₂; LiQS₂; V₂O₅; LiV₂O₅; LiIO₂; LiNiVO₄; Li_{(3-f)}J₂(PO₄)₃ (0≤f≤2); Li_{(3-f)}Fe₂(PO₄)₃ (0≤f≤2); and LiFePO₄. In the above formulas, A is Ni, Co, Mn, or a combination thereof; B is Al, Ni, Co, Mn, Cr, Fe, Mg, Sr, V, a rare-earth element, or a combination thereof; D is O, F, S, P, or a combination thereof; E is Co, Mn, or a combination thereof; F is F, S, P, or a combination thereof; G is Al, Cr, Mn, Fe, Mg, La, Ce, Sr, V, or a combination thereof; Q is Ti, Mo, Mn, or a combination thereof; I is Cr, V, Fe, Sc, Y, or a combination thereof; and J is V, Cr, Mn, Co, Ni, Cu, or a combination thereof.

The cathode binder acts to bind cathode active material particles together and improve the bonding between a cathode active material and a cathode current collector. Examples of the cathode binder include polyvinylidene fluoride (PVDF), poly(vinylidene fluoride)-co-hexafluoropropylene (PVDF-co-HFP), polyvinyl alcohol, polyacrylonitrile, carboxymethyl cellulose (CMC), starch, hydroxypropyl cellulose, recycled cellulose, polyvinylpyrrolidone, tetrafluoroethylene, polyethylene, polypropylene, ethylene-propylene-diene polymer (EPDM), sulfonated-EPDM, styrene butadiene rubber (SBR), fluoro rubber, and/or various suitable copolymers thereof, and any single one or a mixture of two or more of these substances may be used for the cathode binder.

The conductor may be any suitable material so long as it has conductivity (e.g., electrical conductivity) and does not cause chemical changes in the battery described herein (e.g., does not cause undesirable chemical changes in the battery), and examples of such conductor include: graphite such as natural graphite or artificial graphite; carbon-based materials such as carbon black, acetylene black, Ketjenblack, channel black, furnace black, lamp black, and thermal black; conductive fibers such as carbon nanotube, carbon fibers, and metal fibers; fluorocarbons; metal powder such as aluminum and nickel powder; conductive whiskers such as zinc oxide and potassium phosphate; conductive metal oxides such as titanium oxides; and conductive materials such as polyphenylene derivatives, and the like.

The content of the conductor may be in the range of about 1 part by weight to about 10 parts by weight, or about 1 part by weight to about 5 parts by weight, with respect to 100 parts by weight of the cathode active material. When the content of the conductor is within the above ranges, the electrode thus produced shows desirable conductivity characteristics.

The solvent may include, but is not limited to, N-methyl pyrrolidone and the like, and the content of the solvent may be in the range of about 20 parts by weight to about 200 parts by weight with respect to 100 parts by weight of the cathode active material. When the content of the solvent is within the above range, the operation of forming a cathode active material layer may be facilitated or improved.

The cathode current collector has a thickness of about 3 μm to about 500 μm, and can be any suitable material so long as it has high conductivity (e.g., high electrical conductivity) and does not cause chemical changes in the battery described herein (e.g., does not cause an undesirable chemical change in the battery). Examples of such material may include stainless steel, aluminum, nickel, titanium, heat-treated carbon, and/or aluminum and/or stainless that is surface-treated with carbon, nickel, titanium, silver, and/or the like. The current collector may include fine bumps on surfaces thereof so as to enhance binding of the cathode active material thereto. The cathode current collector may be used in any of various suitable forms such as a film, a sheet, a foil, a net, a porous body, foam, and/or a non-woven fabric.

Apart from the above, an anode active material layer-forming composition may be prepared by mixing together an anode active material, a binder, and a solvent.

Examples of the anode active material may include: a material that allows for the reversible intercalation/deintercalation of lithium ions; lithium metal; a lithium metal alloy; a material that can be doped into or undoped from lithium; transition metal oxides, and a combination thereof.

Examples of the materials that allow for the reversible intercalation/deintercalation of lithium ions may include carbon materials, for example, any suitable carbon-based anode active material used in lithium secondary batteries. Examples of the carbon-based anode active material may include crystalline carbon and amorphous carbon, or a combination thereof may be used. Examples of the crystalline carbon may include graphite, including artificial graphite or natural graphite in shapeless, plate, flake, spherical or fiber form. Examples of the amorphous carbon may include soft carbon or hard carbon, mesophase pitch carbides, calcined cokes, and the like.

Examples of the lithium metal alloy may include an alloy of lithium metal with a metal selected from the group consisting of Na, K, Rb, Cs, Fr, Be, Mg, Ca, Sr, Si, Sb, Pb, In, Zn, Ba, Ra, Ge, Al, and Sn.

Examples of the material that can be doped into or undoped from lithium may include silicon-based materials such as Si, SiOx (0<x<2), and Si-Q alloys (here, Q is an element selected from the group consisting of alkali metals, alkali earth metals, elements in Group 13, elements in Group 14, elements in Group 15, elements in Group 16, metals, rare-earth elements and a combination thereof, and is not Si), Si-carbon composites, Sn, SnO₂, Sn—R (here, R is an element selected from the group consisting of alkali metals, alkali earth metals, elements in Group 13, elements in Group 14, elements in Group 15, elements in Group 16, metals, rare-earth elements and a combination thereof, and is not Si), and Sn-carbon composites. In some embodiments, at least one of the aforementioned members in a combination with SiO₂ may be used. The elements Q and R each may be one selected from the group consisting of Mg, Ca, Sr, Ba, Ra, Sc, Y, Ti, Zr, Hf, Rf, V, Nb, Ta, db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ge, P, As, Sb, Bi, S, Se, Te, Po, and a combination thereof.

Examples of the transition metal oxides may include lithium titanium oxides.

Examples of the anode binder may include, but are not limited to, poly(vinylidene fluoride-co-hexafluoropropylene) copolymer (PVDF-co-HFP), polyvinylidenefluoride, polyacrylonitrile, polymethylmethacrylate, polyvinyl alcohol, carboxymethylcellulose (CMC), starch, hydroxypropyl cellulose, recycled cellulose, polyvinylpyrrolidone, tetrafluoroethylene, polyethylene, polypropylene, polyacrylic acid, ethylene-propylene-diene monomer (EPDM), sulfonated EPDM, styrene butadiene rubber (SBR), fluoro rubber, polyacrylic acid, and polymers obtained by substituting hydrogens of the aforementioned members with Li, Na, Ca, or the like, binder polymers of various suitable types or kinds such as various suitable copolymers, and/or the like.

The anode active material layer may further include a thickening agent.

The thickening agent may be at least one selected from among CMC, carboxyethyl cellulose, starch, recycled cellulose, ethyl cellulose, hydroxymethyl cellulose, hydroxyethyl cellulose, hydroxypropyl cellulose, and polyvinyl alcohol. For example, CMC may be used for the thickening agent.

The content of the solvent may be within about a range of about 100 parts by weight to about 300 parts by weight with respect to 100 parts by weight of the total weight of the anode active material. When the content of the solvent is within the above range, the operation of forming the anode active material layer may be facilitated or improved.

If the anode active material layer has conductivity (e.g., electrical conductivity) conferred thereto, there may be no need for a conductor. The anode active material layer may further include a conductor, if needed. The conductor may be any suitable material so long as it has conductivity (e.g., electrical conductivity) and does not cause chemical changes in the battery described herein (e.g., does not cause undesirable chemical changes in the battery), and examples of the conductor may include: graphite such as natural graphite or artificial graphite; carbon-based materials such as carbon black, acetylene black, Ketjenblack, channel black, furnace black, lamp black, and thermal black; conductive fibers such as carbon fibers and metal fibers; conductive tubes such as carbon nanotubes; fluorocarbons; metal powder such as aluminum and nickel powder; conductive whiskers such as zinc oxide and potassium phosphate; conductive metal oxides such as titanium oxides; and conductive materials such as polyphenylene derivatives, and the like. The conductor may be carbon black, and, for example, may be carbon black having an average particle diameter of up to several tens of nanometers.

When the anode active material layer contains a conductor, the content of the conductor may be in a range of about 0.01 parts by weight to about 10 parts by weight, about 0.01 parts by weight to about 5 parts by weight, or about 0.1 parts by weight to about 2 parts by weight, with respect to 100 parts by weight of the total weight of the anode active material layer.

The anode current collector may be generally prepared to a thickness of about 3 μm to about 500 μm. The anode current collector is not particularly limited and may be any suitable material so long as it has conductivity (e.g., electrical conductivity) and does not cause chemical changes in the battery described herein (e.g., does not cause undesirable chemical changes in the battery), and examples of the anode current collector may include copper, stainless steel, aluminum, nickel, titanium, heat-treated carbon, copper and/or stainless steel surface-treated with carbon, nickel, titanium, silver, etc., and aluminum-cadmium alloys, and the like. As described with respect to the cathode current collector above, the anode current collector may include fine bumps formed on surfaces thereof so as to enhance binding of the anode active material thereto. The anode current collector may be used in any of various suitable forms such as a film, a sheet, a foil, a net, a porous body, foam, and/or a non-woven fabric.

A separator may be placed between the anode and the cathode prepared according to the processes above.

The separator used above has a pore diameter of about 0.01 μm to about 10 μm, and generally has a thickness of about 5 μm to about 30 μm. As an example, for the separator, a sheet or a non-woven fabric made of glass fiber, and/or olefin polymers such as polypropylene and/or polyethylene, may be used. When a solid electrolyte, such as a polymer and/or the like, is used as the electrolyte, the solid electrolyte may function as a separator.

The lithium salt-containing nonaqueous electrolyte may be formed of a lithium salt and a nonaqueous liquid electrolyte. For the nonaqueous electrolyte, a nonaqueous liquid electrolyte, an organic solid electrolyte, an inorganic solid electrolyte, and/or the like may be used.

Examples of the nonaqueous electrolyte may include, but are not limited to, aprotic organic solvents such as N-methyl-2-pyrrolidone, propylene carbonate, ethylene carbonate, butylene carbonate, dimethyl carbonate, diethyl carbonate, gamma-butyrolactone, 1,2-dimethoxyethane, 2-methyltetrahydrofuran, dimethyl sulfoxide, 1,3-dioxolane, N,N-formamide, N,N-dimethylformamide, dioxolane, acetonitrile, nitromethane, methyl formate, methyl acetate, triethyl phosphate, trimethoxy methane, dioxolane derivatives, sulfolane, methyl sulfolane, 1,3-dimethyl-2-imidazolidinone, propylene carbonate derivatives, tetrahydrofuran derivatives, ether, methyl propionate, and ethyl propionate.

Examples of the organic solid electrolyte may include, but are not limited to, polyethylene derivatives, polyethylene oxide derivatives, polypropylene oxide derivatives, phosphoric acid ester polymers, polyester sulfide, polyvinyl alcohol, polyvinylidene fluoride, and the like.

Examples of the inorganic solid electrolyte may include, but are not limited to, nitrides, halides, and sulfates of Li, such as Li₃N, LiI, Li₅NI₂, Li₃N—LiI—LiOH, Li₂SiS₃, Li₄SiO₄, Li₄SiO₄—LiI—LiOH, Li₃PO₄—Li₂S—SiS₂, and the like.

The lithium salt is a material that easily dissolves in the nonaqueous electrolyte, and examples of the lithium salt may include, but are not limited to, LiCl, LiBr, LiI, LiClO₄, LiBF₄, LiB₁₀Cl₁₀, LiPF₆, LiCF₃SO₃, LiCF₃CO₂, LiAsF₆, LiSbF₆, LiAlCl₄, CH₃SO₃Li, (CF₃SO₂)₂NLi, (FSO₂)₂NLi, lithium chloroborate, and a combination thereof.

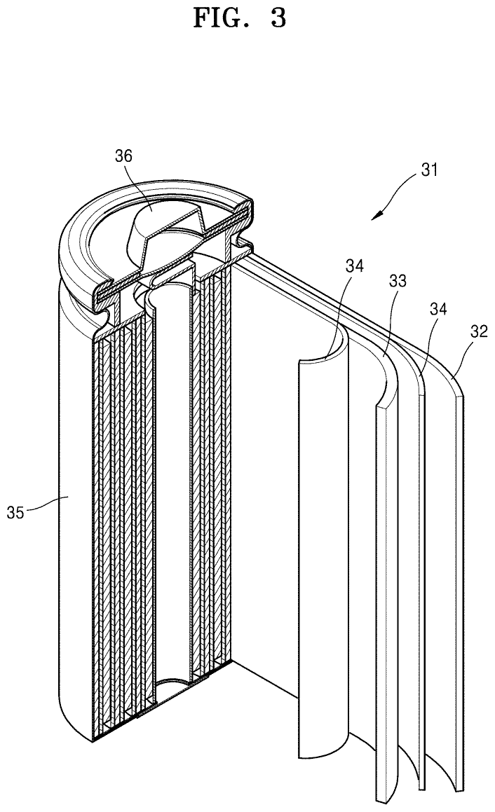

FIG. 3 is a schematic diagram of a representative structure of a lithium secondary battery according to one example.

Referring to FIG. 3, a lithium secondary battery (31) includes a cathode (33), an anode (32), and a separator (34). An electrode assembly, in which the cathode (33), the anode (32), and the separator (34), are wound or folded, is accommodated within a battery case (35). Depending on the shape of the battery, the electrode assembly in which the cathode and the anode are stacked in an alternating fashion, with the separator therebetween, may be formed. Further, the battery case (35) has an organic electrolyte solution injected therein and then is sealed with a cap and an assembly (36), to form the lithium secondary battery (31). The battery case (35) may be a cylindrical type or kind of battery case, a polygonal type or kind of battery case, and a thin-film type or kind of battery case. For example, the lithium secondary battery (31) may be a large-size thin-film type or kind of battery. The lithium secondary battery may be a lithium-ion battery. The above battery structure, once accommodated within a pouch, is immersed in an organic electrolyte solution and then sealed, to thereby form a lithium-ion polymer battery. In addition, the above battery structure may be stacked in multiple layers to form a battery pack, and such a battery pack may be used in all types or kinds of devices that require high capacity and high output. For example, such a battery pack may be used in a laptop, a smartphone, an electric vehicle, and the like.

Hereinbelow, the subject matter of the present disclosure will be described in greater detail through Examples and Comparative Examples. However, the following examples are provided only to illustrate the subject matter of the present disclosure, and are not intended to limit the scope of the present disclosure.

### Example 1

A first mixture was obtained by mixing together cobalt oxide Co₃O₄ (D50:4.5 μm), aluminum hydroxide Al(OH)₃, lithium carbonate, and a magnesium precursor MgCO₃, and the first mixture was raised to a temperature of 1,088° C. at a temperature elevation rate of 4.5° C./min, and by performing a first heat-treatment at this temperature for 5 hours, a first calcined product, lithium cobalt-based oxide having a large particle size Li_{1.04}Mg_{0.005}Co_{0.977}Al_{0.018}O₂ (D50:19 μm), was obtained.

The contents of the cobalt oxide Co₃O₄ (D50:4.5 μm), the aluminum hydroxide Al(OH)₃, and the lithium carbonate in the first mixture were stoichiometrically controlled so as to form a cathode active material of a composition shown in Table 1. Here, the molar ratio (Li/Me) of lithium with respect to metal (Me) was 1.04. Here, the content of the metal represents a total sum of magnesium, cobalt, and aluminum.

Apart from the above, a second mixture was obtained by mixing together cobalt oxide Co₃O₄ (D50:2.5 μm), aluminum hydroxide Al(OH)₃, lithium carbonate, and a magnesium precursor MgCO₃, and the second mixture was raised to a temperature of 940° C. at a temperature elevation rate of 4.5° C./min, and by performing a second heat-treatment at this temperature for 3 hours, a first calcined product, lithium cobalt-based oxide having a small particle size Li_{1.04}Mg_{0.005}Co_{0.977} Al_{0.018}O₂ (D50:3.5 μm), was obtained. Here, the molar ratio (Li/Me) of lithium with respect to metal (Me) was 1.04.

A third mixture was obtained by mixing together the lithium cobalt-based oxide having the large particle size Li_{1.04}Mg_{0.005}Co_{0.977}Al_{0.018}O₂ (D50:19 μm) and the lithium cobalt-based oxide having the small particle size Li_{1.04}Mg_{0.005}Co_{0.977}Al_{0.01802} (D50:3.5 μm), obtained from the above processes, in a weight ratio of 8:2, and then adding titanium dioxide and cobalt oxide thereto. The molar ratio (Li/Me) of lithium with respect to metal (Me) in the third mixture was controlled to be within a range of 0.99 to 1.

By performing a third heat-treatment on the third mixture at about 900° C., a bimodal lithium cobalt-based oxide containing the lithium cobalt-based oxide having the large particle size Li_{1.04} Mg_{0.005} Co_{0.977} Al_{0.018}O₂ (D50:19 μm) and the lithium cobalt-based oxide having the small particle size Li_{1.04} Mg_{0.005} Co_{0.977}Al_{0.018}O₂ (D50:3.5 μm), was obtained. A lithium titanium-based compound was in the form of islands on surfaces of the lithium cobalt-based oxide, and the composition of the lithium cobalt-based oxide, which is a cathode active material, was as shown in Table 1 below.

### Example 2-4

Lithium cobalt-based oxide having the corresponding composition as shown in Table 1 was obtained in substantially the same manner described in Example 1, except that the contents of the respective precursors in the first mixture, the second mixture, and the third mixture were adjusted such that the content of aluminum in the lithium cobalt-based oxide has the corresponding composition shown in Table 1 below.

### Example 5

Lithium cobalt-based oxide having the corresponding composition shown in Table 1 was prepared in substantially the same manner as described in Example 1, except that the D50 of the cobalt oxide Co₃O₄ used in the preparation of the first mixture was changed from 4.5 μm to 7.5 μm.

### Comparative Example 1

Lithium cobalt-based oxide having the corresponding composition shown in Table 1 was prepared in substantially the same manner as described in Example 1, except that aluminum hydroxide and cobalt hydroxide were added to the mixture of the lithium cobalt-based oxide having the large particle size Li_{1.04}Mg_{0.005}Co_{0.98}Al_{0.01802} (D50:19 μm) and the lithium cobalt-based oxide having the small particle size Li_{1.04} Mg_{0.005}Co_{0.98}Al_{0.015}O₂ (D50:3.5 μm) during the third heat-treatment.

### Comparative Example 2

Lithium cobalt-based oxide having the corresponding composition shown in Table 1 was prepared in substantially the same manner as described in Example 4, except that the molar ratio (Li/Me) of lithium with respect to metal (Me) for the first heat-treatment and the second heat-treatment was changed from 1.04 to 1.02.

The large lithium cobalt-based oxide prepared in Comparative Example 2 had an average particle diameter of 8.7 μm.

### Comparative Example 3

Lithium cobalt-based oxide having the corresponding composition shown in Table 1 was prepared in substantially the same manner as described in Example 4, except that the temperature elevation rate in the first heat-treatment and the second heat-treatment was changed to 2° C./min.

The large lithium cobalt-based oxide prepared in Comparative Example 3 had an average particle diameter of 15 μm.

### Comparative Example 4

Lithium cobalt-based oxide having the corresponding composition shown in Table 1 was prepared in substantially the same manner as described in Example 4, except that the D₅₀ of the cobalt precursor, cobalt oxide Co₃O₄, used in preparation of the first mixture was changed to 7.5 μm.

Table 1 shows the contents of aluminum doped in lithium cobalt-based oxide and the contents of aluminum on the surface of lithium cobalt-based oxide in the lithium cobalt-based oxides prepared in Examples 1 to 5 and the lithium cobalt-based oxides prepared in Comparative Examples 1 to 4. Here, the contents of aluminum in the respective examples were confirmed by inductively coupled plasma (ICP) analysis (e.g., inductively coupled optical emission spectroscopy (ICP-OES) analysis).

Table 2 shows a summary of preparation process conditions for the lithium cobalt-based oxides prepared in Examples 1 to 5 and Comparative Examples 1 to 4.

TABLE 1

| | | Al doping | Al coating |
|---|---|---|---|
| | | content | content |
| Item | Composition | (ppm) | (ppm) |
| Example 1 | Li_{1.00}Mg_{0.0048}Co_{0.9764}Al_{0.0173}Ti_{0.0015}O₂ | 4460 | 0 |
| Example 2 | Li_{1.00}Mg_{0.0048}Co_{0.9753}Al_{0.0184}Ti_{0.0015}O₂ | 4840 | 0 |
| Example 3 | Li_{1.00}Mg_{0.0048}Co_{0.9733}Al_{0.0204}Ti_{0.0015}O₂ | 5055 | 0 |
| Example 4 | Li_{1.00}Mg_{0.0048}Co_{0.9712}Al_{0.0225}Ti_{0.0015}O₂ | 5610 | 0 |
| Example 5 | Li_{1.00}Mg_{0.0048}Co_{0.9764}Al_{0.0173}Ti_{0.0015}O₂ | 4460 | 0 |
| Comparative | Li_{1.00}Mg_{0.0048}Co_{0.9780}Al_{0.0172}O₂ | 3750 | 580 |
| Example 1 | | | |
| Comparative | Li_{1.00}Mg_{0.0049}Co_{0.9706}Al_{0.0230}Ti_{0.0015}O₂ | 5610 | 0 |
| Example 2 | | | |
| Comparative | Li_{1.00}Mg_{0.005}Co_{0.971}Al_{0.024}Ti_{0.0015}O₂ | 5610 | 0 |
| Example 3 | | | |
| Comparative | Li_{1.00}Mg_{0.005}Co_{0.971}Al_{0.024}Ti_{0.0015}O₂ | 5610 | 0 |
| Example 4 | | | |

TABLE 2

| | Large particle, | | | Small particle, | | |
|---|---|---|---|---|---|---|
| | First heat-treatment | | | First heat-treatment | | |
| | cobalt precursor | | | cobalt precursor | | |
| | size (D50) (um) | | | size (D50) (μm) | | |
| | for lithium | | | for lithium | | |
| | cobalt-based | | Temperature | cobalt-based | | Temperature |
| | oxide having | Li/Me | elevation | oxide having | Li/Me | elevation |
| | a large | molar | rate (° | a small | molar | rate (° |
| Item | particle size | ratio | C./min) | particle size | ratio | C./min) |
| Example 1 | 4.5 | 1.04 | 4.5 | 2.5 | 1.04 | 4.5 |
| Example 2 | 4.5 | 1.04 | 4.5 | 2.5 | 1.04 | 4.5 |
| Example 3 | 4.5 | 1.04 | 4.5 | 2.5 | 1.04 | 4.5 |
| Example 4 | 4.5 | 1.04 | 4.5 | 2.5 | 1.04 | 4.5 |
| Example 5 | 7 | 1.04 | 4.5 | 2.5 | 1.04 | 4.5 |
| Comparative | 4.5 | 1.04 | 4.5 | 2.5 | 1.04 | 4.5 |
| Example 1 | | | | | | |
| Comparative | 4.5 | 1.02 | 4.5 | 2.5 | 1.04 | 4.5 |
| Example 2 | | | | | | |
| Comparative | 4.5 | 1.04 | 2 | 2.5 | 1.04 | 4.5 |
| Example 3 | | | | | | |
| Comparative | 7.5 | 1.04 | 4.5 | 2.5 | 1.04 | 4.5 |
| Example 4 | | | | | | |

### Manufacturing Example 1: Preparation of Lithium Secondary Battery (Coin Half Cell)

By removing air bubbles from a mixture of the cathode active material obtained according to Example 1, polyvinylidene fluoride, and carbon black, as a conductor, and by using a mixer, a slurry for cathode active material layer formation in which these components were uniformly (e.g., substantially uniformly) dispersed, was prepared. Solvent, N-methyl-2-pyrrolidone, was added to the mixture, and the mixing ratio of the composite cathode active material, polyvinylidene fluoride, and carbon black was 98:1:1 by weight. The slurry prepared according to the above process was coated onto an aluminum foil and formed to a thin electrode sheet by using a doctor blade, and the formed sheet was dried at 135° C. for 3 hours and more, and then subjecting the dried sheet to rolling and vacuum drying processes, a cathode was formed.

A separator (thickness: about 10 μm) formed of a porous polyethylene (PE) film was placed between the cathode and a lithium anode, and by injecting an electrolyte solution, a lithium secondary battery was formed. For the electrolyte solution, a solution including 1.1 M LiPF₆ dissolved in a solvent containing ethylene carbonate (EC), ethyl methyl carbonate (EMC), and dimethyl carbonate (DMC) in a volume ratio of 3:4:3, was used.

### Manufacturing Examples 2-4 and Comparative Manufacturing Examples 1-4

Lithium secondary batteries were prepared in substantially the same manner described in Manufacturing Example 1, except that when preparing a cathode, the cathode active materials of Examples 2-4 and the cathode active materials of Comparative Examples 1-4 were prepared instead of the cathode active material of Example 1.

### Evaluation Example 1: dQ/dV Analysis

The lithium secondary batteries manufactured according to Manufacturing Examples 1-4 and Comparative Manufacturing Examples 1-4 were evaluated for charge-discharge characteristics and the like, using a charge-discharge tester.

The process of evaluating the charge-discharge characteristics is described in greater detail below.

Constant-current charging at a current level of 0.05 C was performed until a voltage of 4.7 V was reached, and then, constant-voltage charging was performed until a current of 0.01 C was reached. Fully charged cells were subjected to a resting period of about 10 minutes, and then cycled through constant-current discharging at a current level of 0.05 C until a voltage of 3 V was reached (first cycle). Subsequently, at 45° C., the charge-discharge cycle was conducted repeatedly for a total of 5 times under the above-described charge-discharge conditions.

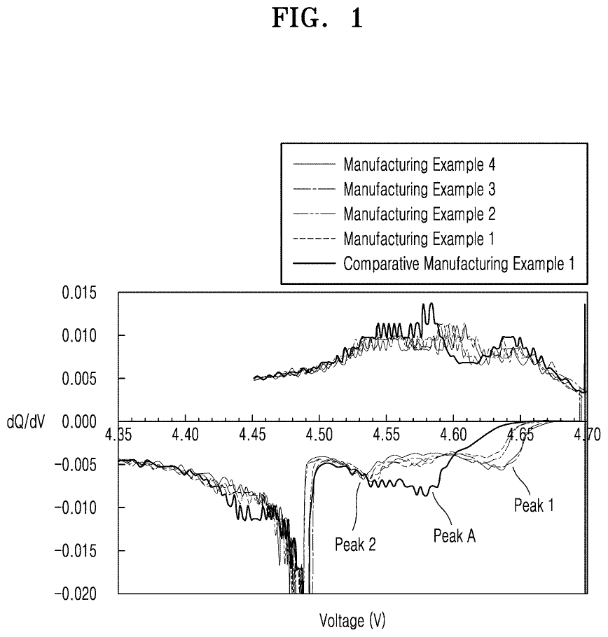

After the first cycle, among discharge peaks obtained from the dQ/dV charge-discharge differential curve distributions that appear in a voltage range of 4.7 V to 3 V, Peak 1 and Peak 2 were investigated and are shown in Table 3 and FIG. 1 below.

Peak 1 appeared in the range of 4.6 V to 4.65 V, and Peak 2 appeared in the range of 4.5 V to 4.55 V. In FIG. 1, charging peaks appear in the range of 4.55 V to 4.65 V, and the discharge peaks appear in the range of 4.5 V to 4.65 V.

FIG. 1 shows dQ/dv charge-discharge differential curves after the first cycle in the lithium batteries manufactured in Manufacturing Examples 1-4 and Comparative Manufacturing Examples 1 to 4.

TABLE 3

| | Peak 2 | Peak 1 | Peak 2 intensity/ |
|---|---|---|---|
| Item | voltage (V) | Voltage (V) | Peak 1 intensity |
| Manufacturing | 4.5-4.55 | 4.6-4.65 | 1.60 |
| Example 1 | | | |
| Manufacturing | | | 1.40 |
| Example 2 | | | |
| Manufacturing | | | 1.30 |
| Example 3 | | | |
| Manufacturing | | | 1.20 |
| Example 4 | | | |
| Comparative | — | — | Only one peak at |
| Manufacturing | | | 4.55-4.60 V |
| Example 1 | | | (see Peak A in FIG. 1) |

As shown in Table 3, in Manufacturing Examples 1 to 4, the Peak 2/Peak 1 intensity ratio show a value greater than 1, as described above. Owing to having an intensity ratio in the above ranges, phase transitions of the lithium cobalt-based oxide are controlled, and thus, it is possible to prepare a lithium secondary battery having improved high-voltage, high-temperature lifespan and high-temperature continuous charging characteristics.

As shown in FIG. 1, in the lithium secondary batteries manufactured in Manufacturing Examples 1 to 4, charging peaks at 4.5 V or higher were moved toward a higher voltage, and discharge peaks also moved toward a higher voltage as compared to cases where the aluminum content is low. As a result, it could be confirmed that phase stabilization at high voltages of 4.5 V or higher was achieved. In addition, as the aluminum doping content increases, high-temperature lifespan characteristics were further improved.

### Evaluation Example 2: Lifespan Characteristics (I) at High Temperature (45° C.) and High Voltage (4.7 V) Conditions

The lithium secondary batteries manufactured in Manufacturing Examples 1-4 and Comparative Manufacturing Examples 1-4 were charged to 100% state of charge (SOC) at 45° C., and while maintaining 4.55 V in a constant current mode, were cut-off at a current rate of 0.05 C. Subsequently, the lithium secondary batteries were discharged at a constant current rate of 0.5 C until a voltage of 3.0 V was reached during discharging (formation process, 1st cycle).

The lithium secondary batteries having undergone the 1st cycle in the formation process were charged at a constant current level of 0.05 C until a voltage of 4.7 V was reached. Fully charged cells were subjected to a resting period of about 10 minutes and then discharged at a constant current level of 0.05 C until a voltage of 3 V was reached, and by repeating this cycle for a total of 5 times, the respective lithium secondary batteries were evaluated.

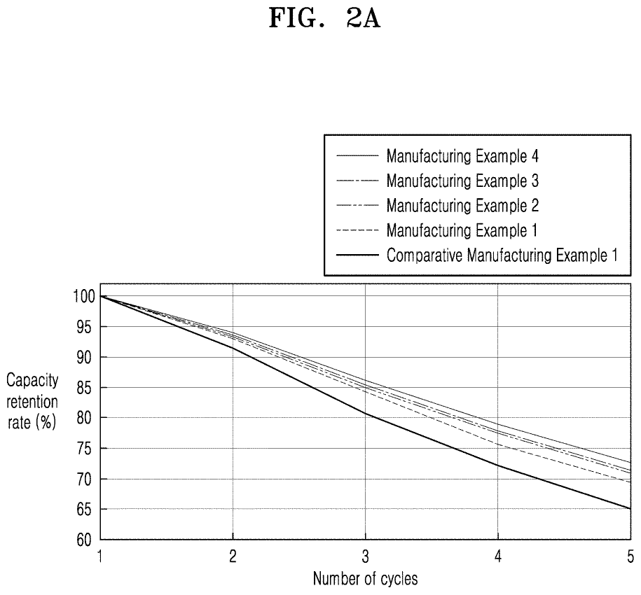

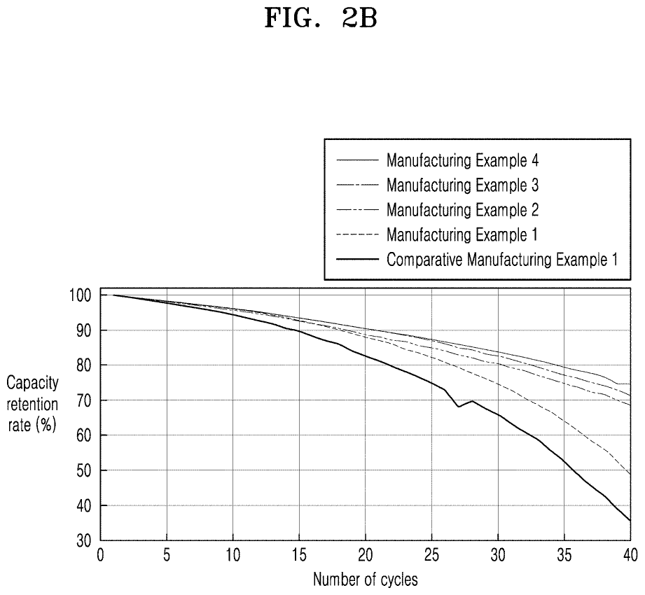

Initial efficiency and lifespan were evaluated according to Equation 1 and Equation 2 below, and the results of evaluation are shown in 4.7 V Lifespan in Table 4 and FIG. 2A. FIG. 2A shows lifespan characteristics of the lithium secondary batteries manufactured in Manufacturing Examples 1-4 and Comparative Manufacturing Example 1.

Initial efficiency (%)=(1st discharge capacity/1st charging capacity)×100 Equation 1

Lifespan (%)=(5th cycle discharge capacity/1st cycle discharge capacity)×100 Equation 2

### Evaluation Example 3: Lifespan Characteristics (II) at High-Temperature (45° C.) and High-Voltage (4.58 V) Condition

The lithium secondary batteries manufactured in Manufacturing Examples 1-4 and Comparative Manufacturing Examples 1-4 were charged to 100% state of charge (SOC) at a constant current level at 45° C., and while maintaining 4.55 V in a constant current mode, were cut-off at a current rate of 0.05 C. Subsequently, the lithium secondary batteries were discharged at a constant current rate of 0.5 C until a voltage of 3.0 V was reached during discharging (formation process, 1st cycle).

The lithium secondary batteries, having undergone the 1st cycle in the formation process, were charged at a constant current level of 0.05 C until a voltage of 4.58 V was reached. Fully charged cells were subjected to a resting period of about 10 minutes and then discharged at a constant current level of 0.05 C until a voltage of 3 V was reached, and by repeating this cycle for a total of 40 times, the respective lithium secondary batteries were evaluated.

Lifespan (@4.58V) characteristics were evaluated according to Equation 3 below, and the results of evaluation are shown in Table 4 and FIG. 2B. FIG. 2B shows lifespan characteristics of the lithium secondary batteries manufactured in Manufacturing Examples 1-4 and Comparative Manufacturing Example 1.

Lifespan (%)=(40th cycle discharge capacity/1st cycle discharge capacity)×100 Equation 3

TABLE 4

| | Charge | Discharge | | Lifespan | Lifespan |
|---|---|---|---|---|---|
| | capacity | capacity | | (%) | (%) |
| Item | (mAh) | (mAh) | ICE(%) | (@4.7 V) | (@4.58 V ) |
| Manufacturing | 209.4 | 195.1 | 93.2 | 69.4 | 48.8 |
| Example 1 | | | | | |
| Manufacturing | 210.3 | 195.6 | 93 | 70.9 | 68.5 |
| Example 2 | | | | | |
| Manufacturing | 210.2 | 195.1 | 92.8 | 71.4 | 71.4 |
| Example 3 | | | | | |
| Manufacturing | 208.8 | 192.6 | 92.2 | 72.7 | 74.8 |
| Example 4 | | | | | |
| Comparative | 208.5 | 194.8 | 93.4 | 65.1 | 35.5 |
| Manufacturing | | | | | |
| Example 1 | | | | | |
| Comparative | 208.5 | 189.9 | 91.1 | — | |
| Manufacturing | | | | | |
| Example 2 | | | | | |
| Comparative | 207.2 | 187.5 | 90.4 | — | |
| Manufacturing | | | | | |
| Example 3 | | | | | |
| Comparative | 208.2 | 189.3 | 0.9 | — | |
| Manufacturing | | | | | |
| Example 4 | | | | | |

As shown in Table 4, it was found that the lithium secondary batteries manufactured in Manufacturing Examples 1 to 4 have improved initial efficiency and lifespan characteristics under a high-temperature and high-voltage condition, as compared to Comparative Manufacturing Examples 1 to 4. In addition, as shown in FIG. 2A and FIG. 2B, it was found that the lithium secondary batteries manufactured in Manufacturing Examples 1 to 4 all have improved lifespan characteristics at high temperatures and high voltages, as compared to Comparative Manufacturing Example 1.

Meanwhile, the lithium secondary batteries manufactured in Comparative Manufacturing Examples 2 and 3, which respectively used the cathode active materials of Comparative Examples 2 and 3 where large particle growth did not occur, showed a decrease in capacity and efficiency characteristics.

### Evaluation Example 4: High-Temperature Continuous Charging Characteristics

Lithium secondary batteries manufactured in Manufacturing Example 1, Manufacturing Example 4, and Comparative Manufacturing Example 1, were charged to 100% state of charge (SOC) at a constant current level at 25° C., and while maintaining 4.55 V in a constant current mode, were cut off at a current rate of 0.2 C.

Subsequently, the lithium secondary batteries were discharged at a constant current rate of 0.2 C until a voltage of 3.0 V was reached during discharging (formation process, 1st cycle).

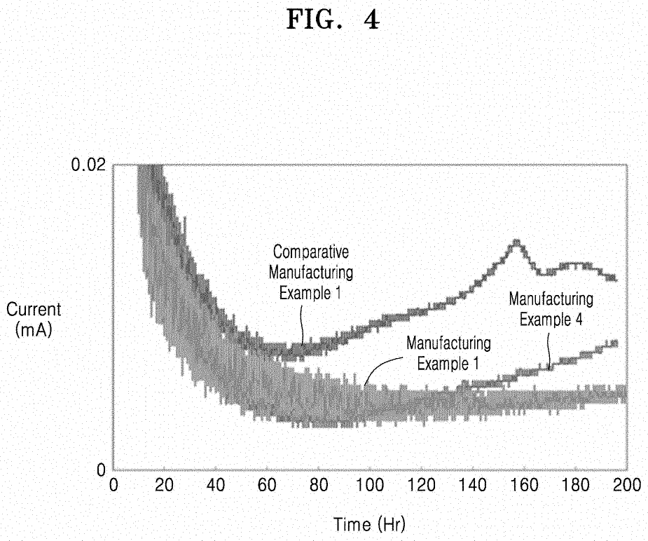

The lithium secondary batteries, having undergone the 1st cycle in the formation process, were continuously charged at a constant current level of 0.2 C over 200 hours until a voltage of 4.58 V was reached, and were subjected to a high-temperature continuous charging while maintaining 4.35 V, and the results thereof were examined and are shown in FIG. 4.

High-temperature continuous charging time is a test to examine trickle charge, and refers to a time taken until a sudden increase in current level occurs during continuous charging.

As can be seen in FIG. 4, it was found that, in comparison to Comparative Manufacturing Example 1, the lithium secondary batteries manufactured in Manufacturing Examples 1 and 4 show a significant increase in high-temperature continuous charging time, and thus have markedly improved high-temperature characteristics.

A lithium cobalt-based oxide according to one example has improved stability at high voltages. Such a lithium cobalt-based oxide may be used to prepare a lithium secondary battery having improved high-temperature lifespan and high-temperature storage characteristics at high voltages.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims, and equivalents thereof.

What is claimed is:

1. A lithium cobalt-based oxide for a lithium secondary battery, the lithium cobalt-based oxide comprising:
aluminum in an amount of 4,000 ppm to 6,500 ppm based on the total weight of lithium cobalt-based oxide,
wherein the lithium cobalt-based oxide comprises large particles and small particles, and in a differential capacity (dQ/dV)-voltage charge-discharge graph of the lithium secondary battery, a discharge peak appearing at a voltage of 4.7 V to 3 V comprises Peak 1 appearing at a discharge voltage of 4.6 V or more, and Peak 2 appearing at a discharge voltage of 4.55 V or less, and
wherein Peak 2 has a greater intensity than that of Peak 1.

2. The lithium cobalt-based oxide of claim 1, wherein the lithium cobalt-based oxide is a compound represented by Formula 1:
LiₐMg_{b}CO_{1-x-y-b}AlₓM_{y}O₂ [Formula 1]
wherein, in Formula 1, 0.9≤a≤1.05, 0.001≤b≤0.01, 0.01<x≤0.03, and 0≤y<0.01, and M is Ti, Mn, Ni, Mo, Zr, Y, W, Sr, Zn, or a combination thereof.

3. The lithium cobalt-based oxide of claim 1, wherein a mixing weight ratio between the large particles and the small particles is 8:2 to 9:1.

4. The lithium cobalt-based oxide of claim 1, wherein a ratio (I_{B}/I_{A}) of intensity (I_{B}) of Peak 2 to intensity (I_{A}) of Peak 1 is 1.1 to 1.7.

5. The lithium cobalt-based oxide of claim 1, wherein Peak 1 appears at a discharge voltage of 4.6 V to 4.65 V, and Peak 2 appears at a discharge voltage of 4.5 V to 4.55 V.

6. The lithium cobalt-based oxide of claim 1, wherein the large particles have a size of 17 μm to 21 μm.

7. The lithium cobalt-based oxide of claim 1, wherein the small particles have a size of 2 μm to 8 μm.

8. The lithium cobalt-based oxide of claim 1, further comprising a lithium-cobalt-titanium oxide on a surface of the lithium cobalt-based oxide.

9. A lithium secondary battery comprising a cathode comprising the lithium cobalt-based oxide of claim 1.

10. A method of preparing a lithium-cobalt composite oxide for a lithium secondary battery, the method comprising:
obtaining a first mixture by mixing together a lithium precursor, an aluminum precursor, and a cobalt precursor having a particle size of 4 μm to 7 μm, and forming a lithium cobalt-based oxide having a large particle size by performing a first heat treatment on the first mixture;
obtaining a second mixture by mixing together a lithium precursor, an aluminum precursor, and a cobalt precursor having a particle size of 2 μm to 3 μm, and forming a lithium cobalt-based oxide having a small particle size by performing a second heat treatment on the second mixture; and
obtaining a third mixture by mixing together the lithium cobalt-based oxide having the large particle size and the lithium cobalt-based oxide having the small particle size, and preparing the lithium cobalt-based composite oxide by performing a third heat treatment on the third mixture, wherein in the preparation of the lithium cobalt-based oxide having the large particle size or the lithium cobalt-based oxide having the small particle size, a mixing molar ratio of lithium with respect to metal (Li/Me) is 1.03 to 1.05, and wherein in the preparation of the lithium cobalt-based oxide having the large particle size or the lithium cobalt-based oxide having the small particle size, a temperature elevation rate is 3° C./min or more.

11. The method of claim 10, wherein in the preparation of the lithium cobalt-based oxide having the large particle size or the lithium cobalt-based oxide having the small particle size, the mixing molar ratio of lithium with respect to metal (Li/Me) is 1.04 to 1.05.

12. The method of claim 10, wherein in the preparation of the lithium cobalt-based oxide having the large particle size or the lithium cobalt-based oxide having the small particle size, the temperature elevation rate is in a range of 4° C./min to 6° C./min.

13. The method of claim 10, wherein a cobalt precursor and a titanium precursor are further added to the third mixture.

14. The method of claim 10, wherein the lithium cobalt-based oxide having the large particle size in the third mixture has a particle size of 17 μm to 21 μm.

15. The method of claim 10, wherein the lithium cobalt-based oxide having the small particle size in the third mixture has a particle size of 2 μm to 8 μm.

16. The method of claim 10, wherein a magnesium precursor is further added when preparing the first mixture and the second mixture.
